(19) United States
(12) Patent Application Publication
(10) Pub. No.: US 2013/0300954 A1
(43) Pub. Date: Nov. 14, 2013

(54) ADHESIVE SHEET FOR IMAGE DISPLAY DEVICE, IMAGE DISPLAY DEVICE, AND ADHESIVE RESIN COMPOSITION

(71) Applicants: Seiji Sunohara, Ibaraki (JP); Junichi Imaizumi, Ibaraki (JP); Tomoyuki Nakamura, Ibaraki (JP); Hajime Nakamura, Ibaraki (JP); Kouji Yamazaki, Ibaraki (JP); Hiroaki Takahashi, Ibaraki (JP); Kazuhiro Makishima, Ibaraki (JP); Kenichi Shinya, Ibaraki (JP); Megumi Tomomatsu, Chiba (JP)

(72) Inventors: Seiji Sunohara, Ibaraki (JP); Junichi Imaizumi, Ibaraki (JP); Tomoyuki Nakamura, Ibaraki (JP); Hajime Nakamura, Ibaraki (JP); Kouji Yamazaki, Ibaraki (JP); Hiroaki Takahashi, Ibaraki (JP); Kazuhiro Makishima, Ibaraki (JP); Kenichi Shinya, Ibaraki (JP); Megumi Tomomatsu, Chiba (JP)

(73) Assignee: Hitachi Chemical Company, LTD, Tokyo (JP)

(21) Appl. No.: 13/992,835

(22) PCT Filed: Dec. 9, 2011
(86) PCT No.: PCT/JP2011/078618

§ 371 Date: Jul. 24, 2013

(30) Foreign Application Priority Data
Dec. 10, 2010 (JP) 2010-276331

(51) Int. Cl. G02F 1/1333; G02F 1/13

(52) U.S. Cl. CPC G02F 1/1333; G02F 1/1313
USPC 349/12; 156/306.6; 428/523; 428/355 CN; 526/260; 522/116

(57) ABSTRACT

The adhesive sheet for an image display device includes a structural unit derived from the following general formula (a), wherein the glass transition temperature is from 10 to 50° C., and tan δ at 40 to 80° C. is from 0.5 to 1.1,

The adhesive sheet for an image display device, an image display device, and an adhesive resin composition for an image display can be provided, which are useful for the prevention of cracking, the attenuation of the stress and the impact, that have excellent transparency, which improve the fog and the flicker in an image displayed on the screen, and which reduce the bubbles, the sullage, and the detachment, particularly under high temperature condition (for example, 80° C. or more) or under high-temperature and humidity condition (for example, 85° C./85% RH).

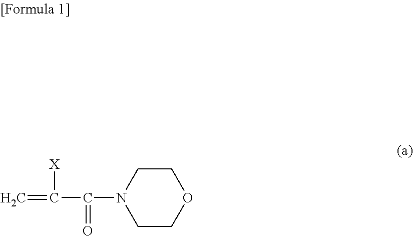

In the formula, X is a hydrogen atom or a methyl group.

### TECHNICAL FIELD

The present invention relates to an adhesive sheet for an image display device, an image display device, and an adhesive resin composition.

### BACKGROUND ART

A typical image display device is exemplified by a liquid crystal display device (LCD). To an optical component such as a liquid crystal display cell of a liquid crystal display device, a polarizing plate or a laminated body with a polarizing plate and a wave plate are laminated. However, the demand for a liquid crystal display device with a built-in touch panel has been increasing in recent years. FIG. 1 shows the schematic diagram of an example of this structure. The liquid crystal display device with a built-in touch panel is composed of a transparent protection plate (glass or plastic substrate) 1, a touch panel 2, a polarizing plate 3, and a liquid crystal display cell 4. In a recent liquid crystal display device, an adhesive layer 5 for laminating the transparent protection plate on the touch panel and an adhesive layer 6 for laminating the touch panel on the polarizing plate are provided in order to prevent the liquid crystal display device from being cracked, to attenuate the stress and the impact, and to improve the visibility. Such a liquid crystal display device is used for various purposes such as a vehicle, an outdoor meter, a mobile phone, and a personal computer. This makes the usage environment extremely severe. Under such a severe condition, the adhesibility of the adhesive layers 5 and 6 laminating each member decreases. This easily causes bubbles, detachment, and the like. Therefore, an adhesive sheet with high durability, which generates no bubbles, detachment, or the like even under the severe condition as described above, is required.

Toward this request, Patent Document 1 describes an adhesive material composition generating no bubbles, sullage, detachment, or the like on the laminating surface even if exposed to a high temperature or a high-temperature and humidity for a long time.

### PRIOR ART DOCUMENTS

### Patent Documents

[Patent Document 1] JP-A-2007-238853

### SUMMARY OF THE INVENTION

However, the material described in Patent Document 1 contains a component with a carboxyl group to improve the adhesion. This acid component may corrode the ITO transparent electrode of a touch panel. Since the materials described in Patent Document 1 have a low glass transition temperature, the handleability is expected to be limited.

An objective of the present invention is to provide an adhesive sheet for an image display device, an image display device, and an adhesive resin composition that are useful for the prevention of cracking, the attenuation of the stress and the impact, that have excellent transparency, that improve the fog and the flicker in an image displayed on a screen, and that reduce the bubbles, the sullage, the detachment, and the like, particularly under high temperature condition (for example, 80° C. or more) or under high-temperature and humidity condition (for example, 85° C./85% RH), and that have excellent handleability.

As a result of their extensive studies, the inventors found that an adhesive sheet containing a structural unit derived from the following general formula (a) and having specific physical properties can solve the above-mentioned problems. The present invention was achieved based on this finding.

Specifically, the present invention provides:

(1) An adhesive sheet for an image display device, including a structural unit derived from the general formula (a), in which the glass transition temperature is from 10 to 50° C., and tan δ at 40 to 80° C. is from 0.5 to 1.1,

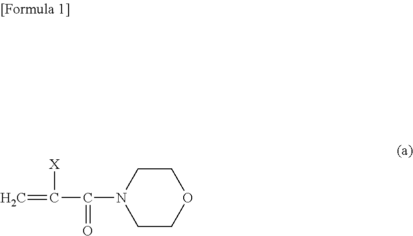

In the formula, X is a hydrogen atom or a methyl group;
(2) An image display device including: the adhesive sheet for an image display device described in the above-mentioned (1), a transparent protection plate, and an image display unit, the transparent protection plate being located at a visual contact side, wherein the adhesive sheet for an image display device is formed between the transparent protection plate and the image display unit; and
(3) An adhesive resin composition for the adhesive sheet described in the above-mentioned (1) including: (A) a (meth)acrylic acid derivative polymer; (B) a (meth)acrylic acid derivative monomer with one (meth)acryloyl group in the molecule; (C) a cross-linker with two (meth)acryloyl functional groups; and (D) a photopolymerization initiator, in which the weight-average molecular weight of the cross-linker with two (meth)acryloyl functional groups (C) is 1.0×10⁵ or less, the content of the cross-linker is 15 mass % or less based on the total amount of the adhesive resin composition, and as the (meth)acrylic acid derivative monomer (B), a monomer with a chemical structure of the general formula (a) is contained in a content of 10 to 40 mass % based on the total amount of the adhesive resin composition,

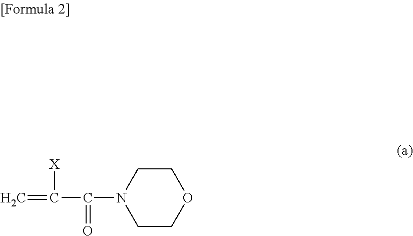

In the formula, X is a hydrogen atom or a methyl group.

The present invention can provides, in an image display device, an adhesive sheet for an image display device (hereinafter sometimes simply referred to as “adhesive sheet”) with the high adhesibility between the transparent protection plate, for example, glass plate, at the visual contact side and the adhesive resin composition and with no detachment, sullage, bubbles, or the like being generated even under high-temperature and humidity, for example, 85° C./85% RH to decrease the visibility of the display. The present invention can also provide an adhesive resin composition suitable for this adhesive sheet. The image display device of the present invention has excellent impact resistance and visibility.

The adhesive sheet for an image display device of the present invention can attach an image display unit to other members necessary for the image display device, for example, an image display unit such as a liquid crystal display unit to a touch panel, an image display unit to a transparent protection plate; or can attach the members placed at the visual contact side from the image display unit of the image display device to each other. The image display device formed by using this sheet has excellent impact resistance and visibility.

### BRIEF DESCRIPTION OF THE DRAWINGS

FIG. 1 shows the schematic diagram illustrating the cross-sectional structure of an example image display device.

FIG. 2 shows the side cross-sectional view in a frame format, illustrating one embodiment of the liquid crystal display device of the present invention.

FIG. 3 shows the side cross-sectional view in a frame format, illustrating the liquid crystal display device equipped with a touch panel of the present invention.

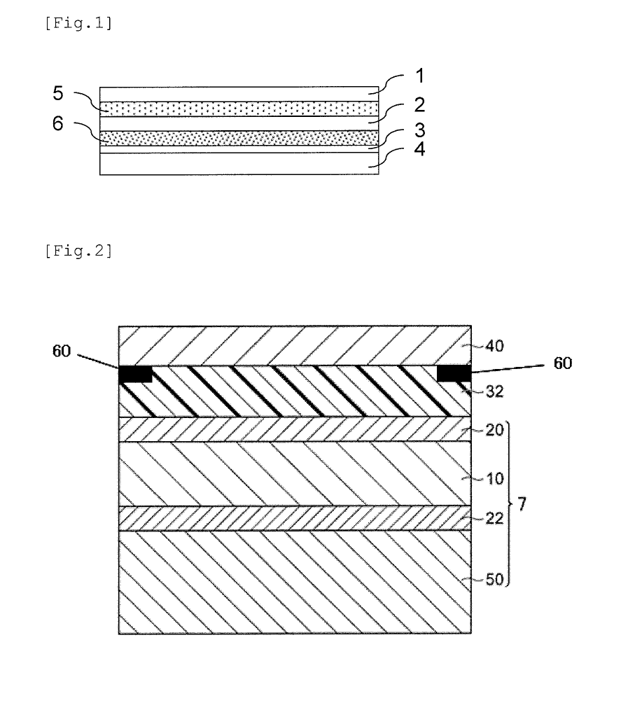

### EXPLANATIONS OF LETTERS OR NUMERALS

1, 40 transparent protection plate (glass or plastic substrate)
2 touch panel
3 polarizing plate
4 liquid crystal display cell
5 adhesive layer for laminating transparent protection plate on touch panel
6 adhesive layer for laminating touch panel on polarizing plate
7 image display unit
10 liquid crystal display cell
20, 22 polarizing plate
30 touch panel
31, 32 transparent resin layer
50 backlight system
60 uneven part

### MODES FOR CARRYING OUT THE INVENTION

### Adhesive Sheet for Image Display Device

The adhesive sheet for an image display device of the present invention includes a structural unit derived from the above-mentioned general formula (a), in which the glass transition temperature is 10-50° C., and tan δ at 40-80° C. is 0.5-1.1.

The adhesive sheet for an image display device of the present invention includes a structural unit derived from the above-mentioned general formula (a). Including such a structural unit produces the beneficial effect of the present invention for generating no detachment, sullage, bubbles, or the like even under high-temperature and humidity, for example, 85° C./85% RH.

The adhesive sheet for an image display device of the present invention is fabricated by using the resin composition as described in detail below. However, a structural unit derived from the above-mentioned general formula (a) may originate from a polymer component or a monomer component that composes the adhesive resin composition. Specifically, a structural unit derived from the general formula (a) may be added to the adhesive sheet of the present invention by containing a skeleton frame derived from (meth)acryloyl morpholine in the polymer component or by containing (meth)acryloyl morpholine in the monomer component. The (meth)acryloyl morpholine may be contained in the polymer component and the monomer component, preferably at least in the monomer component.

The structural unit derived from the above-mentioned general formula (a) is preferably 10-40 mass % based on the total amount of the adhesive sheet for an image display device.

10 mass % or more and 40 mass % or less of the structural unit sufficiently produces the above-mentioned effect of the present invention. From the above-mentioned viewpoint, the content of the structural unit derived from the general formula (a) is preferably 15-35 mass %, particularly preferably 18-32 mass %.

The adhesive sheet for an image display device of the present invention also preferably has a structural unit derived from an alkyl(meth)acrylate with an alkyl group having 4-18 carbon atoms. Specifically, it is preferably that this structural unit be represented by the following general formula (b) and contained in a content of 30-90 mass % based on the total amount of the adhesive sheet for an image display device from the viewpoint of the adhesion, the transparency, and the handleability. From the above-mentioned viewpoint, the content is more preferably 40-85 mass %, particularly preferably 50-80 mass %.

The structural unit derived from an alkyl(meth)acrylate with an alkyl group having 4-18 carbon atoms may be contained in a polymer component or a monomer component composing the below-mentioned adhesive resin composition or may be contained both of the polymer component and the monomer component.

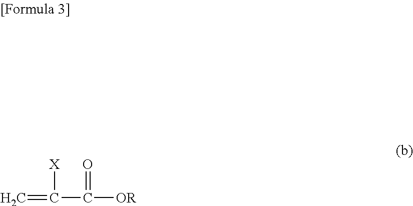

In the formula, R is an alkyl group with 4-18 carbon atoms, and X is a hydrogen atom or a methyl group. R is preferably an alkyl group with 6-12 carbon atoms.

The adhesive sheet for an image display device of the present invention has the following physical properties. Specifically, the glass transition temperature is 10-50° C., and tan δ at 40-80° C. is 0.5-1.1.

Tan δ is a value calculated by dividing a loss elastic modulus with a storage elastic modulus. As the loss elastic modulus and the storage elastic modulus, values measured by a broadband dynamic viscoelasticity measuring instrument were used. Specifically, the measurement was conducted in the following way.

### Measurement of Glass Transition Temperature, Loss Elastic Modulus, and Storage Elastic Modulus

An adhesive sheet with a thickness of 0.5 mm, a width of 10 mm, and a length of 10 mm was prepared and then measured with a broadband dynamic viscoelasticity measuring instrument (Solids Analyzer RSA-II, available from Pheometric Scientific) under measurement conditions of a share sandwich mode, a frequency of 1.0 Hz, a temperature of −40-80° C., and a temperature elevation rate of 5° C./minute.

The glass transition temperature (Tg) of the present application was determined as the temperature when tan δ indicates the peak in the range of the above-mentioned measurement temperature. In case of two or more tan δ peaks being observed to this temperature range, the glass transition temperature was determined as the temperature at the largest tan δ value.

In the adhesive sheet for an image display device of the present invention, if the glass transition temperature is less than 10° C., the adhesive sheet for an image display device may hardly be formed, or bubbles and detachment may be generated under high temperature or under high-temperature and humidity. If the glass transition temperature exceeds 50° C., the embeddedness may decrease when the transparent protection plate, the touch panel, or the polarizing plate as described below has an uneven part. From the above-mentioned viewpoint, the glass transition temperature preferably falls within the range of 10-30° C., more preferably 15-30° C.

If tan δ at 40-80° C. is less than 0.5, detachment and bubbles are generated under a severe service condition. In the present application, to simulate the evaluation under a severe service condition, the accelerated test was conducted, in which the adhesive sheet is subjected to autoclave treatment. This treatment leads to problems of generating bubbles and the like (see Comparative example 3).

On the other hand, if tan δ at 40-80° C. exceeds 1.1, the embeddedness may decrease when the transparent protection plate, the touch panel, or the polarizing plate as described below has an uneven part. From the above-mentioned viewpoint, tan δ at 40-80° C. preferably falls within in the range of 0.5-1.0, more preferably 0.6-1.0.

In the adhesive sheet for an image display device of the present invention, the adhesibility to a glass substrate (soda-lime glass) and an acrylic resin substrate at 80° C. is preferably 5-30 N/10 mm, more preferably 7-30 N/10 mm, particularly preferably 8-30 N/10 mm.

The adhesive sheet for an image display device of the present invention can be obtained by curing the below-mentioned adhesive resin composition through irradiation with active energy lines.

The method of fabricating the adhesive sheet in the present invention is described below.

### Method of Fabricating Adhesive Sheet for Image Display Device

The adhesive sheet in the present invention is obtained by applying an adhesive resin composition containing the above-mentioned component (a) and optionally the above-mentioned component (b) to a substrate in a form of sheet and then by irradiating the applied adhesive resin composition with active energy lines. The light source in active energy lines preferably has light emission distribution at a wavelength of 400 nm or less. For example, a low-pressure mercury lamp, a medium-pressure mercury lamp, a high-pressure mercury lamp, an ultra-high pressure mercury lamp, a chemical lamp, a black light lamp, a metal halide lamp, and a micro wave excitation mercury lamp can be used. The irradiation energy is not limited in particular but typically about 500-5000 mJ/cm².

The adhesive sheet of the present invention has moderate adhesibility and reworkability with no bubbles in a desired thickness. Furthermore, the adhesive sheet of the present invention can have a thickness providing excellent impact relaxation. The thickness of the adhesive sheet of the present invention is not limited in particular by the use and the method but preferably about 0.02-3 mm, more preferably about 0.1-1 mm, particularly preferably 0.15-0.5 mm. The thickness falling within this range produces a particularly excellent effect as a transparent adhesive sheet for laminating an optical member on a display.

The adhesive sheet of the present invention may be in a form of film formed on a substrate or may be placed between a cover film provided on this film-formed substrate and another cover film. Furthermore, after formed on a substrate in a form of film, the adhesive sheet of the present invention may be in a form of film alone peeled from the substrate.

The substrate is preferably, for example, a polymer film of polyethylene terephthalate, polypropylene, polyethylene, and polyester. Among these, a poly ethylene terephthalate film (hereinafter referred to as “PET film”) is more preferable. The thickness of the substrate is preferably 50 μm or more and 200 μm or less, more preferably 60 μm or more and 150 μm or less, particularly preferably 70 μm or more and 130 μm or less. The planar shape of the substrate is preferably larger than that of the adhesive sheet. The outer edge of the substrate preferably projects outwardly from that of the adhesive sheet. The length between the projected outer edge of the substrate and the outer edge of the adhesive sheet is preferably 2 mm or more and 20 mm or less, more preferably 4 mm or more and 10 mm or less from the viewpoint of the easy handling and detachment and from the viewpoint of enabling attached dust to be further decreased. When the planar shape of the adhesive sheet and the substrate is rectangle, the length between the projected outer edge of the substrate and the outer edge of the adhesive sheet is preferably 2 mm or more and 20 mm or less, more preferably 4 mm or more and 10 mm or less for at least one side, particularly preferably for all the sides.

The cover film is, for example, a polymer film of polyethylene terephthalate, polypropylene, polyethylene, and polyester. Among these, a poly ethylene terephthalate film (hereinafter referred to as “PET film”) is preferable. The thickness of the cover film is preferably 25 μm or more and 150 μm or less, more preferably 30 μm or more and 100 μm or less, particularly preferably 40 μm or more and 75 μm or less. The planar shape of the cover film is preferably larger than that of the adhesive sheet. The outer edge of the cover film preferably projects outwardly from that of the adhesive sheet. The length between the projected outer edge of the cover film and the outer edge of the adhesive sheet is preferably 2 mm or more and 20 mm or less, more preferably 4 mm or more and 10 mm or less from the viewpoint of the easy handling and detachment and from the viewpoint of enabling dust to be further decreased. When the planar shape of the adhesive sheet and the cover film is rectangle, the length between the projected outer edge of the cover film and the outer edge of the adhesive sheet is preferably 2 mm or more and 20 mm or less, more preferably 4 mm or more and 10 mm or less for at least one side, particularly preferably for all the sides.

The peeling strength between the cover film and the adhesive sheet is lower than that between the substrate and the adhesive sheet. The peeling strengths between the substrate and the adhesive sheet and between the cover film and the adhesive sheet can be adjusted, for example, by the surface treatment of the substrate and the cover film, and the like. The surface treatment includes, for example, demolding treatment using a silicone compound or a fluorine compound.

In the adhesive sheet for an image display device of the present invention, the cover film tends to be unable to be peeled off if the glass transition temperature is less than 10° C.

### Adhesive Resin Composition

The adhesive resin composition of the present invention contains (A) a (meth)acrylic acid derivative polymer, (B) a (meth)acrylic acid derivative monomer with one (meth)acryloyl group in the molecule, (C) a cross-linker with two (meth)acryloyl functional groups, and (D) a photopolymerization initiator.

(A) (meth)acrylic Acid Derivative Polymer

The (meth)acrylic acid derivative polymer (A) in the present invention is obtained by polymerizing a monomer with one (meth)acryloyl group in the molecule alone or by copolymerizing this monomer in combination with two or more kinds. As long as not undermining the effect of the present invention, a compound with two or more (meth)acryloyl groups in the molecule or a polymeric compound with no (meth)acryloyl groups (for example, a compound with one polymeric unsaturated bond in the molecule, such as acrylonitrile, styrene, vinyl acetate, ethylene, and propylene or a compound with two or more polymeric unsaturated bonds in the molecule, such as divinylbenzene) may be copolymerized.

The monomer composing the (meth)acrylic acid derivative polymer (A) includes, for example, (meth)acrylic acid; (meth)acrylic acid amide; (meth)acryloyl morpholine (a compound of the above-mentioned formula (a)); alkyl(meth)acrylates with an alkyl group having 1-18 carbon atoms, such as methyl(meth)acrylate, ethyl(meth)acrylate, n-butyl(meth)acrylate, isobutyl(meth)acrylate, tert-butyl(meth)acrylate, n-pentyl(meth)acrylate, n-hexyl(meth)acrylate, n-octyl(meth)acrylate, isooctyl(meth)acrylate, 2-ethylhexyl(meth)acrylate, isodecyl(meth)acrylate, dodecyl(meth)acrylate(n-lauryl(meth)acrylate), and stearyl(meth)acrylate; (meth)acrylates with an aromatic ring, such as benzyl(meth)acrylate and phenoxyethyl(meth)acrylate; (meth)acrylates with an alkoxy group, such as butoxy ethylene glycol(meth)acrylate, butoxy diethylene glycol(meth)acrylate, and methoxy triethylene glycol(meth)acrylate; (meth)acrylates with a cycloaliphatic group, such as cyclohexyl(meth)acrylate, isobornyl(meth)acrylate, and dicyclopentanyl(meth)acrylate; (meth)acrylates with a hydroxyl group, such as 2-hydroxyethyl(meth)acrylate, 3-hydroxypropyl(meth)acrylate, and 4-hydroxybutyl(meth)acrylate; tetrahydrofurfuryl(meth)acrylate; (meth)acrylamide derivatives such as N,N-dimethylaminoethyl(meth)acrylate, N,N-dimethylaminopropyl(meth)acrylamide, N,N-dimethyl(meth)acrylamide, N-isopropyl(meth)acrylamide, N,N-diethyl(meth)acrylamide, and N-hydroxyethyl(meth)acrylamide; (meth)acrylates with an isocyanate group, such as 2-(2-methacryloyloxyethyloxy)ethylisocyanate and 2-(meth)acryloyloxyethyl isocyanate; polyethylene glycol monomethyl ether(meth)acrylates such as tetraethylene glycol monomethyl ether(meth)acrylate, hexaethylene glycol monomethyl ether(meth)acrylate, octaethylene glycol monomethyl ether(meth)acrylate, and nonaethylene glycol methyl ether(meth)acrylate; a polypropylene glycol monomethyl ether(meth)acrylate such as heptapropylene glycol monomethyl ether(meth)acrylate; a polyethylene glycol ethyl ether(meth)acrylate such as tetraethylene glycol ethyl ether(meth)acrylate; and polyethylene glycol mono(meth)acrylates such as tetraethylene glycol mono(meth)acrylate, hexaethylene glycol mono(meth)acrylate, and octapropylene glycol mono(meth)acrylate.

Among these above-mentioned compounds, a (meth)acrylate with an alkyl group having 4-18 carbon atoms, which is represented by in the above-mentioned formula (b), is preferable, and a (meth)acrylate with an alkyl group having 6-12 carbon atoms is further more preferable. The content ratio of the (meth)acrylate is preferably 50-90 mass %, further more preferably 60-80 mass % based on one molecule of copolymerized polymer.

The content falling within the range of 65-75 mass % improves the adhesion of a transparent substrate of glass, plastic, or the like in the processability after the adhesive sheet is formed, A polymer with such a copolymerization rate can generally be obtained by mixing and copolymerizing each monomer in the same rate as the above-mentioned copolymerization rate. The conversion is preferably brought close to substantially 100 mass %.

The monomer copolymerizing a (meth)acrylate with an alkyl group having carbon atoms 4-18 is not limited to those as described above but preferably has polar groups such as a hydroxyl group, a morpholino group, an amino group, a carboxyl group, a cyano group, a carbonyl group, and a nitro group. A (meth)acrylate with these polar groups improves the adhesion to a transparent substrate of plastic or the like.

The monomer preferably contains a (meth)acrylate represented by the above-mentioned formula (a), which has a morpholino group. Particularly, when the component (B) contains no (meth)acryloyl morpholine as described in detail, the component (A) preferably contains (meth)acryloyl morpholine.

The weight-average molecular weight of the (meth)acrylic acid derivative polymer (A), which is a value converted based on the standard polystyrene calibration curve by gel permeation chromatography (GPC), is preferably 80,000-700,000. The weight-average molecular weight of 80,000 or more can provides adhesibility generating no detachment from a transparent substrate and the like under high temperature environment (for example, 80° C. or more) or under high-temperature and humidity environment (for example, 85° C./85% RH). On the other hand, the weight-average molecular weight of 700,000 or less increases the viscosity of the adhesive resin composition not too much, providing excellent processability for producing the adhesive sheet. From the above-mentioned viewpoint, the weight-average molecular weight is preferably 100,000-500,000.

As the polymerization process of the (meth)acrylic acid derivative polymer, well-known polymerization processes such as solution polymerization, emulsion polymerization, suspension polymerization, and bulk polymerization can be used.

As the polymerization initiator for polymerizing the (meth)acrylic acid derivative polymer (A), a compound generating a radical by heat can be used, including organic peroxides such as benzoyl peroxide, t-butylperbenzoate, cumene hydroperoxide, diisopropyl peroxydicarbonate, di-n-propyl peroxydicarbonate, di(2-ethoxyethyl)peroxydicarbonate, t-butyl peroxyneodecanoate, t-butyl peroxypivalate, (3,5,5-trimethylhexanoyl)peroxide, dipropionyl peroxide, diacetyl peroxide, and didodecyl peroxide; and azo compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methyl propionate), 4,4′-azobis(4-cyanovaleric acid), 2,2′-azobis(2-hydroxymethyl propionitrile), and 2,2′-azobis[2-(imidazoline-2-yl)propane].

The content of the (meth)acrylic acid derivative polymer (A) is preferably 15-80 mass %, more preferably 15-60 mass %, particularly preferably 15-50 mass % based on the total amount of the adhesive resin composition. When the content of the (meth)acrylic acid derivative polymer (A) is 10-80 mass %, the viscosity of the adhesive resin composition falls within the range of an appropriate viscosity for fabricating the adhesive sheet to provide excellent processability. The obtained adhesive sheet has excellent adhesion to a transparent substrate of glass, plastic, or the like.

(B) (meth)acrylic Acid Derivative Monomer

The component (B) in the adhesive resin composition of the present invention is a monomer with one (meth)acryloyl group in the molecule, preferably containing a monomer ((meth)acryloyl morpholine) with the chemical structure of the above-mentioned general formula (a).

In the component (B) of the present invention, another monomer with one (meth)acryloyl group in the molecule is used in addition to (meth)acryloyl morpholine. For this monomer, well-known materials can be used with no limitation in particular and may be used in combination with two kinds or more.

Specifically, this monomer is the same as those forming a (meth)acrylic acid derivative polymer described regarding the above-mentioned component (A), including the above-mentioned monomers other than (meth)acryloyl morpholine.

In the present invention, from the viewpoint of the adhesion and the transparency, the monomer contains an alkyl(meth)acrylate with an alkyl group having preferably 4-18, more preferably 6-12 carbon atoms. Particularly, an alkyl(meth)acrylate with an alkyl group having 4-18 carbon atoms is more preferably used with a hydroxyl group-containing (meth)acrylate represented by the following general formula (x).

CH₂═CXCOO(CₚH₂ₚO)_{q}H (x)

In the formula, X represents H or CH₃, p represents an integer of 2-4, and q represents an integer of 1-10.

The alkyl(meth)acrylate with an alkyl group having 4-18 carbon atoms includes n-butyl(meth)acrylate, n-pentyl(meth)acrylate, n-hexyl(meth)acrylate, n-octyl(meth)acrylate, isooctyl(meth)acrylate, 2-ethylhexyl(meth)acrylate, dodecyl(meth)acrylate, and stearyl(meth)acrylate. Among these, n-butyl(meth)acrylate, isooctyl(meth)acrylate, 2-ethylhexyl(meth)acrylate, n-octyl(meth)acrylate, and the like are preferable, and 2-ethylhexyl(meth)acrylate is particularly preferable. Furthermore, an acrylates is more preferable than a methacrylate. These (meth)acrylates may be used in combination with two or more kinds.

The hydroxyl group-containing (meth)acrylate represented by the general formula (x) includes hydroxyl group-containing (meth)acrylates such as 2-hydroxyethyl(meth)acrylate, 1-hydroxyethyl(meth)acrylate, 2-hydroxypropyl(meth)acrylate, 3-hydroxypropyl(meth)acrylate, 1-hydroxypropyl(meth)acrylate, 4-hydroxybutyl(meth)acrylate, 3-hydroxybutyl(meth)acrylate, 2-hydroxybutyl(meth)acrylate, and 1-hydroxybutyl(meth)acrylate; polyethylene glycol mono(meth)acrylates such as diethylene glycol mono(meth)acrylate and triethylene glycol mono(meth)acrylate; polypropylene glycol mono(meth)acrylates such as dipropylene glycol mono(meth)acrylate and tripropylene glycol mono(meth)acrylate; and polybutylene glycol mono(meth)acrylates such as dibutylene glycol mono(meth)acrylate and tributylene glycol mono(meth)acrylate. Among these, 2-hydroxyethyl(meth)acrylate, 1-hydroxyethyl(meth)acrylate, 2-hydroxypropyl(meth)acrylate, 3-hydroxypropyl(meth)acrylate, 1-hydroxypropyl(meth)acrylate, 4-hydroxybutyl(meth)acrylate, 3-hydroxybutyl(meth)acrylate, 2-hydroxybutyl(meth)acrylate, and 1-hydroxybutyl(meth)acrylate are preferable, 2-hydroxyethyl(meth)acrylate and 4-hydroxybutyl(meth)acrylate are more preferable, and 4-hydroxybutyl(meth)acrylate is highly preferable. These (meth)acrylates may be used in combination with two or more kinds.

The content of the (meth)acrylic acid derivative monomer (B) in the present invention is preferably 15-80 mass % based on the total amount of the adhesive resin composition. The content of the (meth)acrylic acid derivative monomer (B) falling within the range of 15-80 mass % allows tan δ of the obtained adhesive sheet to fit within the range obtained in the present invention. The obtained adhesive sheet laminated between the glass substrate and the glass substrate reduces the generated bubbles and the detachment after a reliability test is performed under high temperature (80° C. or more) and under high-temperature and humidity (85° C./85% RH). From the above-mentioned viewpoint, the content of the (meth)acrylic acid derivative monomer (B) is more preferably 30-80 mass %, particularly preferably 40-80 mass %.

(C) Cross-Linker with Two (meth)acryloyl Functional Groups

Specifically, the cross-linker with two (meth)acryloyl functional groups (C) is suitably exemplified by those represented by the following general formulas (c)-(h).

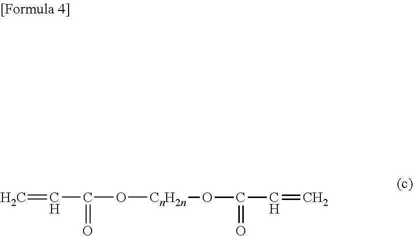

In the formula (c), n is an integer of from 1 to 20.

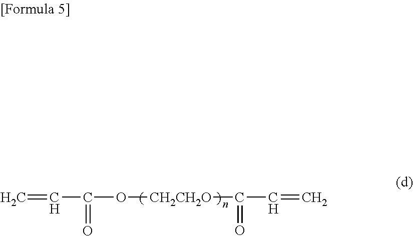

In the formula (d), n is an integer of from 1 to 20.

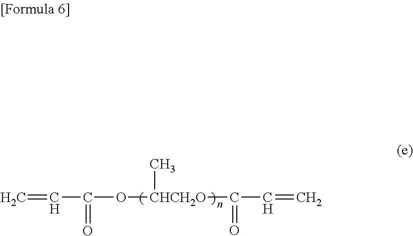

In the formula (e), n is an integer of from 1 to 20.

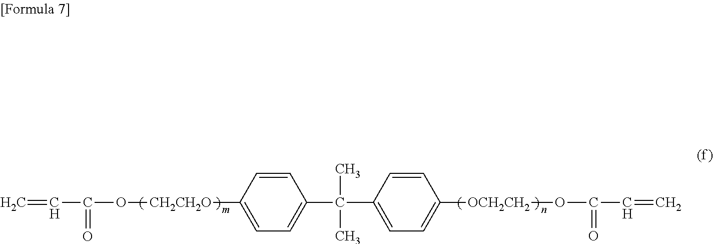

In the formula (f), m and n are each independently an integer of from 1 to 10.

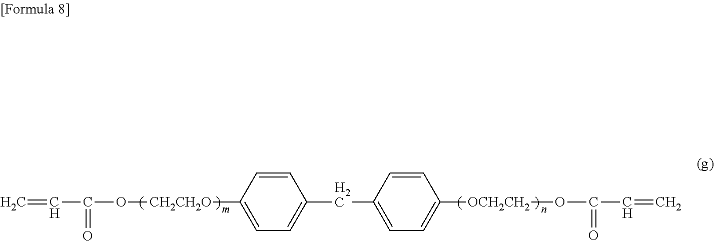

In the formula (g), m and n are each independently an integer of from 1 to 10.

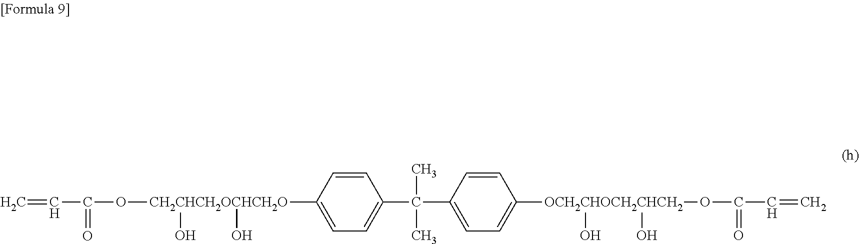

In addition, a urethane di(meth)acrylate with a urethane bond can be used as the component (C).

The urethane di(meth)acrylate with a urethane bond preferably has a polyalkylene glycol chain from the viewpoint of the compatibility. Furthermore, the urethane di(meth)acrylate with a urethane bond preferably has a cycloaliphatic structure from the viewpoint of the transparency.

If the cross-linker with two (meth)acryloyl functional groups has low compatibility with the (meth)acrylic acid derivative polymer (A) and the acrylic acid derivative monomer (B), the cured material may yield a white turbidity.

The cross-linker with two (meth)acryloyl functional groups (C) in the present invention has a weight-average molecular weight of preferably 100,000 or less, more preferably 300-100,000, particularly preferably 500-10,000 from the viewpoint of enabling the bubbles and the detachment to be reduced under high temperature or under high-temperature and humidity.

The content of cross-linker with two (meth)acryloyl functional groups (C) is preferably 15 mass % or less based on the total amount of the adhesive resin composition. The content of 15 mass % or less increases the crosslink density not too much so as to provide the adhesive sheet with sufficient adhesion and high elasticity and without fragility. Specifically, the content of 15 mass % or less can provides the adhesive sheet with a tan δ at 40-80° C. of 0.5 or more, an adhesibility to glass (soda-lime glass) at 80° C. of 5 N/10 mm or more, and an adhesibility to an acrylic resin board (PMMA) of 5 N/10 mm or more. From the viewpoint of enabling the bubbles and the detachment to be reduced under high temperature or under high-temperature and humidity, the content of the component (C) is more preferably 10 mass % or less, further more preferably 3 mass % or less, particularly preferably 2.5 mass % or less, most preferably 2 mass % or less.

The lower limit of the content of the cross-linker is not limited in particular but preferably 0.1 mass % or more.

### (D) Photopolymerization Initiator

The photopolymerization initiator (D) used in the present invention promotes curing reaction by the irradiation of active energy lines. The active energy lines are herein referred to as ultraviolet rays, electron rays, α rays, β rays, γ rays, and the like.

The photopolymerization initiator is selected with no limitation in particular. As the photopolymerization initiator, well-known materials based on benzophenone, anthraquinone, benzoyl, a sulfonium salt, a diazonium salt, and an onium salt can be used.

Specifically, the photopolymerization initiator includes aromatic ketone compounds such as benzophenone, N,N′-tetramethyl-4,4′-diaminobenzophenone(Michler's ketone), N,N-tetraethyl-4,4′-diaminobenzophenone, 4-methoxy-4,4′-dimethylamino benzophenone, α-hydroxyisobutyl phenone, 2-ethyl anthraquinone, t-butyl anthraquinone, 1,4-dimethyl anthraquinone, 1-chloro anthraquinone, 2,3-dichloro anthraquinone, 3-chloro-2-methyl anthraquinone, 1,2-benzo anthraquinone, 2-phenyl anthraquinone, 1,4-naphthoquinone, 9,10-phenanthraquinone, thioxanthone, 2-chlorothioxanthone, 1-hydroxycyclohexyl phenyl ketone, 2,2-dimethoxy-1,2-diphenylethane-1-one, 2-hydroxy-2-methyl-1-phenylpropane-1-one, and 2,2-diethoxyacetophenone; benzoin compounds such as benzoin, methylbenzoin, and ethylbenzoin; benzoin ether compounds such as benzoin methylether, benzoin ethylether, benzoin isobutylether, and benzoin phenylether; benzyl compounds such as benzyl and benzyl dimethylketal; an ester compound of β-(acridine-9-yl)(meth)acrylic acid; acridine compounds such as 9-phenylacridine, 9-pyridyl acridine, and 1,7-diacridinoheptane; 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer, 2-(2,4-dimethoxyphenyl)-4,5-diphenylimidazole dimer, and 2-(p-methylmercaptophenyl)-4,5-diphenylimidazole dimer; 2-benzil-2-dimethylamino-1-(4-morpholinophenyl)-1-butanone; 2-methyl-1-[4-(methylthio)phenyl]-2-morpholino-1-propane; bis(2,4,6-trimethylbenzoyl)-phenylphosphine oxide; and oligo(2-hydroxy-2-methyl-1-(4-(1-methyl vinyl)phenyl)propanone).

Particularly, as the polymerization initiator never coloring the adhesive resin composition, α-hydroxyalkylphenone compounds such as 1-hydroxycyclohexyl phenyl ketone, 2-hydroxy-2-methyl-1-phenyl-propane-1-one, 1-[4-(2-hydroxyethoxy)-phenyl]-2-hydroxy-2-methyl-1-propane-1-one; acylphosphine oxide compounds such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide; and oligo(2-hydroxy-2-methyl-1-(4-(1-methyl vinyl ketone)phenyl)propanone), and a mixture thereof are preferable.

For fabricating an particularly thick sheet, acylphosphine oxide compounds such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide are preferable.

For decreasing the odor of the sheet, oligo(2-hydroxy-2-methyl-1-(4-(1-methyl vinyl)phenyl)propanone) is preferable. These polymerization initiators may be used in combination with two or more kinds.

The content of the photopolymerization initiator (D) in the present invention is preferably 0.1-5 mass %, further more preferably 0.1-3 mass % based on the total amount of the adhesive resin composition. The content of 5 mass % or less provides a high transmissivity to the obtained adhesive sheet and never yellows the hue.

### Other Additives

The adhesive resin composition for the adhesive sheet of the present invention may optionally contain various additives in addition to the above-mentioned (A), (B), (C), and (D). In the present invention, the containable various additives include, for example, a polymerization inhibitor such as p-methoxyphenol added to improve the storage stability of an adhesive resin composition containing (A), (B), (C), and (D); an antioxidant such as triphenylphosphine added to enhance the heat resistance of the adhesive sheet obtained by curing the adhesive resin composition with light; a photostabilizer such as HALS (hindered amine light stabilizer) added to enhance the tolerance of light such as ultraviolet rays; and a silane coupling agent added to enhance the adhesion to glass and the like. The obtained adhesive sheet formed by using the adhesive resin composition for the adhesive sheet of the present invention is placed between a substrate of a polymer film such as a poly ethylene terephthalate film or the like and a cover film of the same polymer film. To control peeling properties of the substrate and the cover film of a poly ethylene terephthalate film or the like, a surfactant based on polydimethylsiloxane, fluorine, or the like can be contained.

These additives may be used alone or in combination with two or more kinds. The content of these additives is typically smaller than the total content of the above-mentioned (A), (B), (C), and (D), generally about 0.01-5 mass % based on the total amount of the adhesive resin composition.

The adhesive resin composition of the present invention can be used as an adhesive by being applied and cured in a liquid state as it is. However, the adhesive resin composition is preferably used as a sheet as described above.

### Image Display Device

The image display device formed by using the adhesive resin composition or the adhesive sheet of the present invention will be explained. The adhesive resin composition and the adhesive sheet of the present invention can be applied to various image display devices. The image display device includes a plasma display (PDP), a liquid crystal display (LCD), a cathode ray tube (CRT), a field emission display (FED), an organic light emitting display (OELD), a 3D display, and an electronic paper (EP). The adhesive resin composition and the adhesive sheet of the present invention can be used to combine and laminate, for example, a functional layer with the functionalities of an antireflection layer, an antifouling layer, a pigment layer, and a hard coating layer of the image display device; a multi-layered object in which this layer formed in a form of film or laminated on an optical filter substrate of a substrate film such as a polyethylene or a polyester film; or a multi-layered object in which a transparent protection plate of glass, an acrylic resin, polycarbonate, or the like, or a functional layer with various functions is formed in a form of film or laminated on this transparent protection plate. The adhesive resin composition and the adhesive sheet can be used as an optical filter combined with such a multi-layered object. The adhesive resin composition of the present invention can also be applied to or filled in these multi-layered objects and then cured.

The antireflection layer only needs to be a layer with antireflection, the visible-light reflectivity of which is 5% or less. As the antireflection layer, a layer processed by a well-known antireflection method can be used for a transparent substrate such as a transparent plastic film.

The antifouling layer is to hardly allow fouling to adhere on the surface. As the antifouling layer, a well-known layer composed of a fluorine resin or a silicone resin can be used to lower the surface tension.

The pigment layer is used to improve the color purity and to decrease unnecessary light when the color purity of light emitted from the image display unit such as a liquid crystal display unit is low. The pigment layer can be obtained by dissolving pigment absorbing an unnecessary part of light in a resin and then by forming or laminating this resin on a substrate film such as a polyethylene or a polyester film.

The hard coating layer is used to increase the surface hardness. The hard coating layer in which an acrylic resin such as urethane acrylate or an epoxy resin such as epoxy acrylate is formed in a form of film or laminated on a substrate film such as a polyethylene film can be used. To improve the surface hardness, transparent protection plates of glass, an acrylic resin, and polycarbonate or these plates on which the hard coating layer is formed in a form of film or laminated can be used.

The adhesive resin composition and the adhesive sheet of the present invention can be used by being laminated on a polarizing plate. In this case, the adhesive resin composition and the adhesive sheet can laminated on the visual contact side of the polarizing plate or the opposite side to the visual contact side.

When used on the visual contact side of the polarizing plate, the antireflection layer, the antifouling layer, and the hard coating layer can be laminated on the further visual contact side of the adhesive sheet. When used between the polarizing plate and the liquid crystal cell, the layer with functionality can be laminated on the visual contact side of the polarizing plate.

In these laminates, the adhesive sheet can be laminated with a roll laminator, a vacuum laminator, or a sheet-fed laminator.

The adhesive sheet is placed between the image display unit and the transparent protection plate (faceplate) on the foremost visual contact side of the image display device, preferably on an appropriate position at the visual contact side. Specifically, the adhesive sheet is preferably used between the image display unit and the transparent protection plate.

In the image display device with a touch panel being combined with the image display unit, the adhesive sheet is preferably used between the touch panel and the image display unit and/or between the touch panel and the transparent protection plate (faceplate). However, as long as being applicable on the structure of the image display device, the adhesive sheet of the present invention is located with no limitation to the above-mentioned locations.

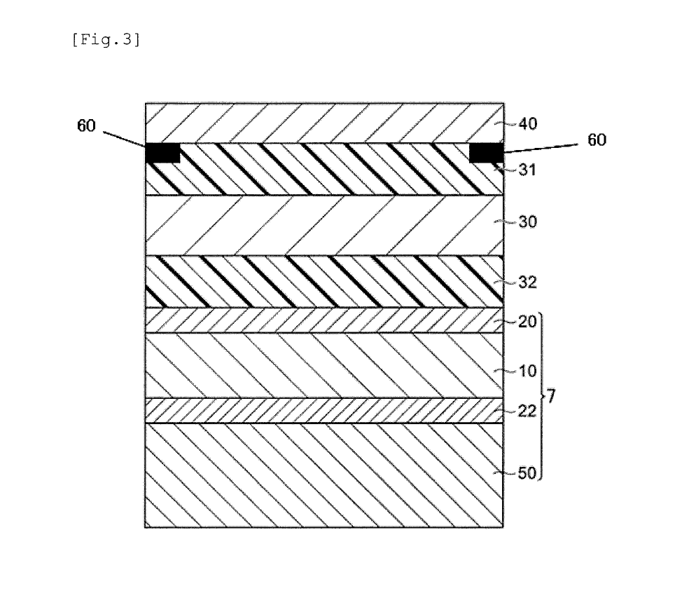

An example of the liquid crystal display device that is one of the image display devices will be explained in detail with reference to FIGS. 2 and 3.

FIG. 2 shows the side cross-sectional view in a frame format, illustrating one embodiment of the liquid crystal display device of the present invention. The liquid crystal display device shown in FIG. 2 is composed of an image display unit 7 in which a backlight system 50, a polarizing plate 22, a liquid crystal display cell 10, and a polarizing plate 20 are laminated in this order; a transparent resin layer 32 provided on the top surface of the polarizing plate 20 to be the visual contact side of the liquid crystal display device; and a transparent protection plate (protection panel) 40 provided on the surface. The transparent resin layer 32 is composed of the adhesive sheet of the present embodiment.

FIG. 3 shows the side cross-sectional view in a frame format, illustrating the liquid crystal display device equipped with a touch panel of an embodiment of the present invention. The liquid crystal display device shown in FIG. 3 is composed of an image display unit 7 in which a backlight system 50, a polarizing plate 22, a liquid crystal display cell 10, and a polarizing plate 20 are laminated in this order; a transparent resin layer 32 provided on the top surface of the polarizing plate 20 to be the visual contact side of the liquid crystal display device; a transparent resin layer 31 provided on the top surface of the touch panel 30; and a transparent protection plate 40 provided on the surface.

The transparent resin layers 31 and 32 are composed of the adhesive sheet of the present embodiment.

In the liquid crystal display device of FIG. 3, the transparent resin layer is placed between the image display unit 7 and the touch panel 30 and between touch panel 30 and the transparent protection plate 40 but only need to be placed between the image display unit 7 and the touch panel 30 or between touch panel 30 and the transparent protection plate 40. When the touch panel is an on-cell type, the touch panel is integrated with a liquid crystal display cell. Specifically, for example, the liquid crystal display cell 10 of the liquid crystal display device of FIG. 2 is replaced with the on-cell type.

The liquid crystal display devices shown in FIGS. 2 and 3 have impact resistance and no false images, providing clear and high-contrast images because the adhesive sheet of the present embodiment is provided as the transparent resin layer 31 or 32.

The liquid crystal display cell 10 composed of a well-known liquid crystal material in the art can be used. The control technique of a liquid crystal material is classified into the TN (Twisted Nematic) system, the STN (Super-twisted nematic) system, the VA (Virtical Alignment) system, the IPS (In-Place-Switching) system, and the like. In the present invention, the liquid crystal display cell may be controlled by any of these systems.

As the polarizing plates 20 and 22, a general polarizing plate can be used in the art. The surface of these polarizing plates may be subjected to treatments such as antireflection, antifouling, and hard coating. The either or both sides of the polarizing plate may be subjected to these surface treatments.

As the touch panel 30, a general touch panel in the art can be used.

The transparent resin layer 31 or 32 can be formed, for example, in a thickness of 0.02-3 mm. Particularly, the curing resin composition of the present embodiment can produce further more excellent effect by thickening the transparent resin. The transparent resin layer 31 or 32 with a thickness of 0.1 mm or more can suitably be used.

As the transparent protection plate 40, a general optical transparent plate can be used. The specific example includes a plate of an inorganic substance such as glass or quartz; resin plates such as an acrylic and a polycarbonate plates; and a resin sheet such as a thick polyester sheet. When high surface hardness is required, plates of glass, acrylate, and the like are preferable, and a glass plate is more preferable. The surface of these transparent protection plates may be subjected to treatments such as antireflection, antifouling, and hard coating. The either or both sides of the transparent protection plate may be subjected to these surface treatments. The transparent protection plate can be used in combination with two or more kinds.

The backlight system 50 is typically composed of a reflection means such as a reflector and a light means such as a lamp.

The above-mentioned liquid crystal display device of FIG. 2 can be produced by a production method including the step of placing the above-mentioned adhesive sheet of the present embodiment between the image display unit and the protection panel.

Specifically, in the image display device shown in FIG. 2, the adhesive sheet of the present invention can previously be fabricated and then laminated on the top surface of the polarizing plate 20 by the above-mentioned lamination.

The alternative production method suitably includes applying the adhesive resin composition of the present invention to the top surface of the polarizing plate 20 and curing this adhesive resin composition to obtain the transparent resin layer 32. The curing can be conducted by irradiating the transparent protection plate side with active energy lines such as ultraviolet (UV) rays.

The above-mentioned liquid crystal display device of FIG. 3 can be produced by a production method including a step of placing the above-mentioned adhesive sheet of the present embodiment between the image display unit and the touch panel and/or between the touch panel and the transparent protection substrate (protection panel). The method of placing the curing resin composition includes the same method as that in the case of the above-mentioned liquid crystal display device of FIG. 2.

Furthermore, the curing can be promoted by exposing light to the laminate containing the adhesive resin composition, by heating this laminate, or the like.

When the transparent protection plate, the touch panel, or the image display unit has 10-80 μm of uneven part (for example, uneven part 60), heating pressure treatment (autoclave treatment) is preferably conducted under the conditions of 40-80° C. (preferably 50-70° C.), 0.3-0.8 MPa (preferably 0.4-0.7 MPa), and 5-60 minutes (preferably 10-50 minutes) after the step of laminating the adhesive sheet for an image display device between the transparent protection plate and the touch panel, between the touch panel and the image display unit, or between the transparent protection plate and the image display unit, from the viewpoint of enabling more bubbles to be removed from near the uneven part.

### EXAMPLES

The present invention will be explained with reference to examples below. The present invention is not limited to these examples.

### Evaluation

The adhesive sheet obtained in each of the examples and the comparative examples was evaluated by the following test method.

### 1. Measurement of Glass Transition Temperature, Storage Elastic Modulus, and Loss Elastic Modulus.

The glass transition temperature, the storage elastic modulus, and the loss elastic modulus were measured by the method described herein.

### 2. Measurement of Adhesibility

The prepared adhesive sheet was cut out in a size with a width of 10 mm and a length of 50 mm. The adhesibility when the adhesive sheet was peeled off 180 degrees was measured with a tensile tester (“RTC-1210” available from Orientec). The adhesive sheet was peeled off at a peeling rate of 300 mm/minute for 3 seconds, and then the adhesibility between the glass substrate and the acrylic resin substrate was measured at measurement temperatures of 25° C. and 80° C.

### 3. Appearance Evaluation

The prepared adhesive sheet was cut out in a size with a width of 50 mm and a length of 100 mm and then laminated on a glass substrate with a size of 50 mm×100 mm×0.7 mm (thickness) under the conditions of 25° C., atmospheric pressure, and a load of 500 g with a rubber roller (roller diameter: 50 mm, roller width: 210 mm).

Subsequently, on this adhesive sheet, the same glass plate and an acrylic resin substrate with a size of 50 mm×100 mm×1.5 mm (thickness) were laminated by using the rubber roller to prepare the following structures, respectively.

(1) The adhesive sheet is placed between the glass substrate and the glass substrate (described as “Structure 1” in the table).
(2) The adhesive sheet is placed between the glass substrate and the acrylic substrate (described as “Structure 2” in the table). Subsequently, these structures were autoclaved (at 60° C. and 0.5 MPa for 30 minutes) to obtain a sample. This sample was left for a set time under the following environmental conditions, and then the appearance (bubbles and detachment) were visually evaluated. The evaluation criterion is as follows.

### Evaluation Criterion

A: No detachment or bubbles are not generated.
B: No detachment but 1 or more and less than δ bubbles are generated.
C: 5 or more bubbles are generated.
-: No sheets can be formed.

### Environmental Condition

(1) High-temperature and humidity test (hereinafter referred to as “85/85”)

The sample was left at 85° C. and 85% RH for 24 hours.

(2) High-temperature test (hereinafter referred to as “100”)

The sample was left at 100° C. for 24 hours.

(3) Heat cycle test (hereinafter referred to as “TCT”)

The heat cycle in which the sample was left at an atmosphere of −40° C. for 30 minutes and then an atmosphere of 100° C. for 30 minutes was conducted (100 times).

### 4. Optical Property Evaluation

The prepared adhesive sheet was cut out in a size with a width of 40 mm and a length of 100 mm, the cover film (poly ethylene terephthalate film) at one side of the adhesive sheet was peeled off, and then this side of the adhesive sheet was laminated on a glass substrate with a size of 50 mm×100 mm×0.7 mm (thickness) with a rubber roller.

Subsequently, the base material substrate (poly ethylene terephthalate film) of the other side was peeled off, and then the adhesive face was measured as follows.

### (1) Measurement of L*, a*, and b*

This measurement was conducted with a spectral colorimeter (CM-A76) available from Konica Minolta.

### (2) Measurement of Haze

This measurement was conducted with a haze meter “NDH 5000” available from NIPPON DENSHOKU INDUSTRIES Co., LTD.

### Preparation Example 1

### Synthesis of (A) Acrylic Acid Derivative Polymer A-1

In a reaction container equipped with a cooling tube, a thermometer, a stirrer, a dropping funnel, and a nitrogen inlet, 84.0 g of 2-ethylhexyl acrylate and 36.0 g of 2-hydroxyethyl acrylate as starting monomers and 150.0 g of methyl ethyl ketone were added. While purged with nitrogen at an air flow of 100 mL/minute, the mixture was heated from a normal temperature (25° C.) to 70° C. for 15 minutes.

Subsequently, while maintained at 70° C., 21.0 g of 2-ethylhexyl acrylate and 9.0 g of 2-hydroxyethyl acrylate were used as additional monomers. Then, a solution dissolving 1.0 g of lauroyl peroxide was prepared and added dropwise to the mixture for 60 minutes, and the obtained mixture was further reacted for 2 hours.

Subsequently, methyl ethyl ketone was distilled away to obtain a copolymer resin of 2-ethylhexyl acrylate and 2-hydroxyethyl acrylate (weight-average molecular weight: 150,000) (the acrylic acid derivative polymer A-1).

The weight-average molecular weight was measured by gel permeation chromatography with tetrahydrofurane (THF) as the solvent by using the following device under the following measurement conditions and determined based on the standard polystyrene calibration curve.

Device: Hitachi, Ltd.

R1 detector: L-3350

Solvent used: THF

Column: Gelpac GL-R420+R430+R440 available from Hitachi Chemical Co., Ltd.

Column temperature: 40° C.

Flow: 2.0 mL/minute

### Preparation Example 2

### Synthesis of (A) Acrylic Acid Derivative Polymer A-2

The acrylic acid derivative polymer A-2 containing acryloyl morpholine (ACMO) was synthesized.

Specifically, a copolymer resin of 2-ethylhexyl acrylate, 2-hydroxyethyl acrylate, and acryloyl morpholine (ACMO) (weight-average molecular weight: 180,000) (the acrylic acid derivative polymer A-2) was obtained in the same way as Preparation example 1 except using 74.5 g of 2-ethylhexyl acrylate, 31.9 g of 2-hydroxyethyl acrylate and 13.6 g of acryloyl morpholine (ACMO) as starting monomers, and 150.0 g of methyl ethyl ketone; using 18.6 g of 2-ethylhexyl acrylate, 8.0 g of 2-hydroxyethyl acrylate, and 3.4 g of acryloyl morpholine (ACMO) as additional monomers and a solution dissolving 1.0 g of lauroyl peroxide.

### Preparation Example 3

### Synthesis of (C) Cross-Linker with Two (meth)acryloyl Functional Groups C-1

In a reaction container equipped with a cooling tube, a thermometer, a stirrer, a dropping funnel, and an air inlet, 223.12 g of polypropylene glycol (molecular weight: 2,000), 76.29 g of hydroxyethyl acrylate modified with 2 mol of ε-caprolactone (trade name: Placcel FA2D, available from Daicel Corporation), 99.68 g of 2-hydroxyethyl acrylate, 0.12 g of p-methoxyphenol as a polymerization inhibitor, and 0.5 g of dibutyltin dilaurate as a catalyst were added. The mixture was heated to 75° C. with air flow. While stirred at 75° C., 49.35 g of isophorone diisocyanate was uniformly added dropwise and reacted for 2 hours.

At the end of dropwise addition, the mixture was reacted for 5 hours, and 44.85 g of 2-hydroxyethyl acrylate was added. Subsequently, this mixture was reacted for 1 hour. After it was confirmed by IR measurement that isocyanate disappeared, the reaction was ended. The polyurethane diacrylate C-1 (weight-average molecular weight: 8,500) (the cross-linker with two (meth)acryloyl functional groups C-1) was obtained, which has polypropylene glycol and isophorone diisocyanate as repeating units and a polymeric unsaturated bond at both ends.

### Preparation Example 4

### Synthesis of (C) Cross-Linker with Two (meth)acryloyl Functional Groups C-2

In a reaction container equipped with a cooling tube, a thermometer, a stirrer, a dropping funnel, and an air inlet, 303.92 g of polypropylene glycol (molecular weight: 2,000), 8.66 g of hydroxyethyl acrylate modified with 2 mol of ε-caprolactone (trade name: Placcel FA2D, available from Daicel Corporation), 99.74 g of 2-hydroxyethyl acrylate, 0.12 g of p-methoxyphenol as a polymerization inhibitor, and 0.5 g of dibutyltin dilaurate as a catalyst were added. The mixture was heated to 75° C. with air flow. While stirred at 75° C., 36.41 g of isophorone diisocyanate was uniformly added dropwise and reacted for 2 hours.

At the end of dropwise addition, the mixture was reacted for 5 hours, and 44.88 g of 2-hydroxyethyl acrylate was furthermore added. Subsequently, this mixture was reacted for 1 hour. After it was confirmed by IR measurement that isocyanate disappeared, the reaction was ended. The polyurethane diacrylate C-2 (weight-average molecular weight: 20,000) (the cross-linker with two (meth)acryloyl functional groups C-2) was obtained, which has polypropylene glycol and isophorone diisocyanate as repeating units and a polymeric unsaturated bond at both ends.

### Example 1

### Composition of Sample and Preparation of Adhesive Sheet

35.8 g of the acrylic acid derivative polymer (A-1) obtained by Preparation example 1, 39.2 g of 2-ethylhexyl acrylate (EHA), 24.3 g of acryloyl morpholine (ACMO), 0.2 g of polypropylene glycol diacrylate (“FANCRYL FA-P240A” represented by the formula (e), average n: 7, available from Hitachi Chemical Co., Ltd), and 0.5 g of 1-hydroxycyclohexyl phenyl ketone (1-184) were weighed and mixed with being stirred to obtain an adhesive resin composition for the adhesive sheet.

Subsequently, the adhesive resin composition for an adhesive sheet obtained as described above was added dropwise to a poly ethylene terephthalate film. The film was covered with polyethylene terephthalate. Then, the adhesive resin composition for an adhesive sheet was applied to the film in a form of sheet with a roller, and the film was irradiated with 2,000 mJ/cm² of ultraviolet ray by using an ultraviolet irradiator to obtain a transparent adhesive sheet. The result of the adhesive sheet evaluated in the above-mentioned way is shown in Table 1.

### Examples 2 to 10 and Comparative Examples 1 to 4

An adhesive sheet was obtained in the same way as Example 1 except the composition of the sample following Tables 1, 2, and 3. The result of the adhesive sheet evaluated in the same way as Example 1 is shown in Tables 1, 2, and 3.

TABLE 1

| | | | Example | | | | | |
|---|---|---|---|---|---|---|---|---|
| Item | | | 1 | 2 | 3 | 4 | 5 | 6 |
| Condition of | Component (A) | Acrylic acid | 35.8 | 35.8 | 35.8 | 35.8 | 35.8 | — |
| composition | | derivative polymer | | | | | | |
| | | A-1 (Preparation | | | | | | |
| | | example 1) | | | | | | |
| | | Acrylic acid | — | — | — | — | — | 35.8 |
| | | derivative polymer | | | | | | |
| | | A-2 (Preparation | | | | | | |
| | | example 2) | | | | | | |
| | Component (B) | EHA | 39.2 | 35.6 | 32.0 | 37.9 | 30.7 | 47.2 |
| | | ACMO | 24.3 | 27.9 | 31.5 | 24.3 | 31.5 | 15.0 |
| | Component (C) | FA-P240A | 0.2 | 0.2 | 0.2 | — | — | — |
| | | Polyurethane | — | — | — | 1.5 | 1.5 | 1.5 |
| | | diacrylate C-1 | | | | | | |
| | Component (D) | I-184 | 0.5 | 0.5 | 0.5 | 0.5 | 0.5 | 0.5 |
| Dynamic | Glass transition temperature (° C.) | | 30 | 39 | 42 | 25 | 45 | 16 |
| viscoelasticity | tan δ | 40° C. | 0.80 | 1.02 | 0.90 | 0.72 | 0.90 | 0.61 |
| | | 60° C. | 0.72 | 0.82 | 0.84 | 0.68 | 0.77 | 0.56 |
| | | 80° C. | 0.76 | 0.78 | 0.72 | 0.68 | 0.62 | 0.56 |
| Adhesibility | Glass substrate | 25° C. | 13.2 | 14.0 | 14.0 | 14.5 | 14.0 | 8.7 |
| (N/10 mm) | | 80° C. | 12.0 | 11.6 | 10.0 | 9.5 | 8.5 | 6.9 |
| | acrylic substrate | 25° C. | 14.4 | 14.4 | 14.0 | 16.2 | 12.7 | 8.2 |
| | | 80° C. | 11.0 | 11.6 | 10.0 | 12.6 | 8.2 | 5.9 |
| Appearance | Structure 1 | 85/85 | A | A | A | A | A | A |
| | | 100 | A | A | A | A | A | A |
| | | TCT | A | A | A | A | A | A |
| | Structure 2 | 85/85 | A | A | A | A | A | A |
| | | 100 | A | A | A | A | A | A |
| | | TCT | A | A | A | A | A | A |
| Optical | L* | | 100 | 99.9 | 100 | 100 | 100 | 98 |
| property | a* | | 0.00 | 0.00 | 0.00 | 0.02 | 0.00 | 0.02 |
| | b* | | 0.01 | 0.00 | 0.00 | 0.00 | 0.00 | 0.01 |
| | Haze | | 0.3 | 0.3 | 0.3 | 0.3 | 0.3 | 0.4 |

TABLE 2

| | | | Example | | | |
|---|---|---|---|---|---|---|
| Item | | | 7 | 8 | 9 | 10 |
| Condition of | Component (A) | Acrylic acid | 30.8 | 32.9 | 30.8 | 35.7 |
| composition | | derivative polymer | | | | |
| | | A-1 (Preparation | | | | |
| | | example 1) | | | | |
| | | Acrylic acid | — | — | — | — |
| | | derivative polymer | | | | |
| | | A-2 (Preparation | | | | |
| | | example 2) | | | | |
| | Component (B) | EHA | 39.3 | 38.3 | 39.3 | 36.3 |
| | | ACMO | 18.7 | 19.0 | 18.7 | 24.2 |
| | | HEA*¹ | 4.2 | 4.3 | 4.2 | — |
| | Component (C) | FA-P240A | — | — | — | 3.3 |
| | | Polyurethane | 6.5 | 5.0 | — | — |
| | | diacrylate C-1 | | | | |
| | | Polyurethane | — | — | 6.5 | — |
| | | diacrylate C-2 | | | | |
| | Component (D) | I-184 | 0.5 | 0.5 | 0.5 | 0.5 |
| Dynamic | Glass transition temperature (° C.) | | 19 | 13 | 12 | 35 |
| viscoelasticity | tan δ | 40° C. | 0.65 | 0.68 | 0.72 | 0.65 |
| | | 60° C. | 0.59 | 0.68 | 0.62 | 0.65 |
| | | 80° C. | 0.61 | 0.75 | 0.47 | 0.60 |
| Adhesibility | Glass substrate | 25° C. | 10.3 | 11.0 | 12.7 | 7.2 |
| (N/10 mm) | | 80° C. | 7.5 | 6.2 | 10.5 | 5.6 |
| | acrylic substrate | 25° C. | 17.0 | 15.8 | 15.2 | 8.2 |
| | | 80° C. | 5.9 | 5.1 | 11.6 | 5.0 |
| Appearance | Structure 1 | 85/85 | A | A | A | A |
| | | 100 | A | A | A | A |
| | | TCT | A | A | A | A |
| | Structure 2 | 85/85 | B | B | B | B |
| | | 100 | B | B | B | B |
| | | TCT | B | B | B | B |
| Optical | L* | | 100 | 100 | 100 | 100 |
| property | a* | | 0.00 | 0.01 | 0.00 | 0.00 |
| | b* | | 0.08 | 0.06 | 0.00 | 0.02 |
| | Haze | | 0.3 | 0.3 | 0.3 | 0.3 |

*¹HEA; 2-hydroxyethyl acrylate

TABLE 3

| | | | Comparative example | | | |
|---|---|---|---|---|---|---|
| Item | | | 1 | 2 | 3 | 4 |
| Condition of | Component (A) | Acrylic acid | 30.8 | 43.5 | 42.6 | 35.7 |
| composition | | derivative polymer | | | | |
| | | A-1 (Preparation | | | | |
| | | example 1) | | | | |
| | | Acrylic acid | — | — | — | — |
| | | derivative polymer | | | | |
| | | A-2 (Preparation | | | | |
| | | example 2) | | | | |
| | Component (B) | EHA | 58.0 | 46.7 | 32.0 | 20.2 |
| | | ACMO | — | — | 8.0 | 38.8 |
| | | HEA*¹ | 4.2 | 4.3 | 3.9 | — |
| | Component (C) | FA-P240A | — | — | — | 3.3 |
| | | Polyurethane | — | 5.0 | 13.0 | 1.5 |
| | | diacrylate C-1 | | | | |
| | | Polyurethane | 6.5 | — | — | — |
| | | diacrylate C-2 | | | | |
| | Component (D) | I-184 | 0.5 | 0.5 | 0.5 | 0.5 |
| Dynamic | Glass transition temperature (° C.) | | −12 | 3 | 17 | 53 |
| viscoelasticity | tan δ | 40° C. | Unmeasurable*² | 0.32 | 0.63 | 0.77 |
| | | 60° C. | Unmeasurable | 0.21 | 0.57 | 0.72 |
| | | 80° C. | Unmeasurable | 0.18 | 0.49 | 0.72 |
| Adhesibility | Glass substrate | 25° C. | Unmeasurable | 6.8 | 7.2 | 13.6 |
| (N/10 mm) | | 80° C. | Unmeasurable | 4.9 | 5.1 | 12.3 |
| | acrylic substrate | 25° C. | Unmeasurable | 5.8 | 8.6 | 12.3 |
| | | 80° C. | Unmeasurable | 3.7 | 5.0 | 11.2 |
| Appearance | Structure 1 | 85/85 | Unmeasurable | C | C | C |
| | | 100 | Unmeasurable | C | C | C |
| | | TCT | Unmeasurable | C | C | C |
| | Structure 2 | 85/85 | Unmeasurable | C | C | C |
| | | 100 | Unmeasurable | C | C | C |
| | | TCT | Unmeasurable | C | C | C |
| Optical | L* | | Unmeasurable | 100 | 100 | 99 |
| property | a* | | Unmeasurable | 0.00 | 0.00 | 0.00 |
| | b* | | Unmeasurable | 0.00 | 0.00 | 0.09 |
| | Haze | | Unmeasurable | 0.3 | 0.3 | 0.3 |

*¹HEA; 2-hydroxyethyl acrylate
*²Unmeasurable due to no film formation

### INDUSTRIAL APPLICABILITY

According to the optical adhesive material resin composition of the present invention, the optical adhesive material sheet with excellent transparency, handleability, and unevenness following capability can be produced. The adhesive material resin sheet can improve the adhesibility and the holding power by crosslinking after laminated so as to exhibit high reliability. Furthermore, since the adhesive material resin sheet contains no monomers with low molecular weight for dilution, the cure shrinkage does not need to be considered, and the skin irritation is low. Therefore, the adhesive resin composition and the adhesive material sheet for an image display device of the present invention are suitable for the application of an image display device. In particular, the adhesive resin composition and the adhesive material sheet are highly useful as a material filled between a panel such as a touch panel and a protection member such a cover glass.

1. An adhesive sheet for an image display device comprising a structural unit derived from the general formula (a), wherein the glass transition temperature is from 10 to 50° C., and tan δ at 40 to 80° C. is from 0.5 to 1.1, 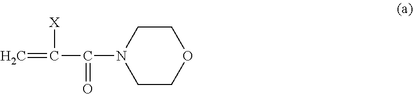
wherein, X is a hydrogen atom or a methyl group.

2. The adhesive sheet for an image display device according to claim 1, wherein the content of the structural unit derived from the general formula (a) is from 10 to 40 mass % based on the total amount of the adhesive sheet for an image display device.

3. The adhesive sheet for an image display device according to claim 1, further comprising a structural unit derived from an alkyl(meth)acrylate with an alkyl group having from 4 to 18 carbon atoms.

4. The adhesive sheet for an image display device according to claim 1, wherein the adhesibility to a glass substrate and an acrylic resin substrate at 80° C. is from 5 to 30 N/10 mm.

5. An image display device comprising: the adhesive sheet for an image display device according to claim 1, a transparent protection plate, and an image display unit, the transparent protection plate being located at a visual contact side,
wherein the adhesive sheet for an image display device is formed between the transparent protection plate and the image display unit.

6. An adhesive resin composition for an adhesive sheet comprising: (A) a (meth)acrylic acid derivative polymer; (B) a (meth)acrylic acid derivative monomer with one (meth)acryloyl group in the molecule; (C) a cross-linker with two (meth)acryloyl functional groups; and (D) a photopolymerization initiator,
wherein the weight-average molecular weight of the cross-linker with two (meth)acryloyl functional groups (C) is 1.0×10⁵ or less, the content of the cross-linker is 15 mass % or less based on the total amount of the adhesive resin composition, and as the (meth)acrylic acid derivative monomer (B), a monomer with a chemical structure of the general formula (a) is contained in a content of 10 to 40 mass % based on the total amount of the adhesive resin composition, 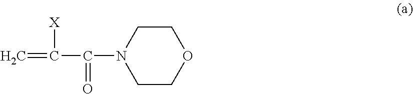
wherein, X is a hydrogen atom or a methyl group.

7. An image display device comprising a layer at the visual contact side,
wherein the layer is formed from the adhesive resin composition according to claim 6, and
wherein the layer is located at the visual side.

8. The image display device according to claim 7 comprising: the layer formed from the adhesive resin composition, a transparent protection plate, a touch panel, and an image display unit,
wherein the layer is formed between the transparent protection plate and the touch panel, or between the transparent protection plate and the image display unit.

9. A method of manufacturing an image display device, the image display device including a transparent protection plate, a touch panel, and an image display unit, comprising the steps of:
laminating the transparent protection plate with the touch panel, the touch panel with the image display unit, or the transparent protection plate with the image display unit by using the adhesive sheet for an image display device according to claim 1, and
conducting a treatment under the conditions of 40° C. to 80° C., 0.3 to 0.8 MPa, and 5 to 60 minutes after the lamination step.
